(19) United States
(12) Patent Application Publication
(10) Pub. No.: US 2019/0377479 A1
(43) Pub. Date: Dec. 12, 2019

(54) AUTOMATIC CONTENT GENERATION BASED ON SOURCE CONTENT AND RE-SIZING OPTIONS

(71) Applicant: ADOBE INC., San Jose, CA (US)

(72) Inventors: KYOSHI IHARA, San Jose, CA (US); SHIVAM GOYAL, Santa Clara, CA (US); SANGEETA VARMA, Sunnyvale, CA (US); MORGAN GURFINKEL, New York, NY (US); BRIAN DUERSCH, Mountain View, CA (US); BHAVIN BHUPENDRA DOSHI, Milpitas, CA (US)

(21) Appl. No.: 16/005,569

(22) Filed: Jun. 11, 2018

(51) Int. Cl. G06F 3/0484; G06F 3/0482; G06Q 30/02

(52) U.S. Cl. CPC G06F 3/04845; G06F 3/04842; G06Q 30/0277; G06F 3/0482

(57) ABSTRACT

The present disclosure relates to generating target content, and in particular, generating target content based on source content and a plurality of re-sizing options. In this regard, preexisting source content is selected and input into a content generation engine. A focal point associated with the source content and at least one re-sizing option are selected. A focal point associated with target content, as well as the location of textual data associated with the target content are determined. Target content is generated to conform to the at least one selected re-sizing option and the determined focal point. The target content is then displayed for further modification in a user-friendly user interface.

### BACKGROUND

With the rapid growth of online marketing focused on deep personalization of content (e.g., targeted advertisements, frequent updating of advertisements), the need for efficient generation and modification of personalized content based on repurposed preexisting content has increased. With the proliferation of the number of channels of distribution and/or devices on which content is distributed to viewers (e.g., potential customers), a content author (e.g., advertiser, marketer, promoter) engaged in personalized content distribution needs to ensure their content conforms to the specific dimension requirements of the chosen channel(s) of distribution and/or device(s). Ensuring conformity to specific dimension helps ensure proper display of the content to viewers. For example, an author may desire to repurpose a preexisting advertisement and distribute it on first and second destination webpages (e.g., an offsite webpage, a third-party webpage). Suppose the first destination webpage allows for the display of exclusively vertical advertisements with specified width and height dimensions, and the second destination webpage allows for the display of exclusively horizontal advertisements with specified width and height dimensions. To distribute the repurposed advertisement to both destination webpages, the preexisting advertisement must be re-sized twice to ensure it conforms to each webpage's unique width and height requirements. Further, an author may wish to modify the advertisement after re-sizing.

To cater to the specifications of a chosen channel of distribution and/or destination webpage, content authors often repurpose preexisting content to generate new content that conforms to the various specifications and/or requirements. Often, the task of re-sizing preexisting content is costly and time-consuming. The cost and time it takes to individually re-size preexisting content increases with an increase in the number of channels of distribution or destination webpages, at least because the number of unique width and height specifications increases with the increasing number of distribution channels and/or webpages. Additionally, to increase personalization of content, a content author may wish to modify the re-sized content. Often, the task of modifying re-sized content is costly and time consuming. The lack of an approachable, user-friendly user interface further impairs a content author's ability to efficiently modify content. In the absence of suitable assistance, content authors manually re-size and modify content. In some cases, the cost and tedium of manual content re-sizing may lead the author to limit the number webpages to distribute the advertisement, thereby limiting content viewership. In other cases, the unavailability of user-friendly content editing tools may increase a need for expert content editors, thereby increasing cost and decreasing efficiency in the generation and distribution of personalized content.

### SUMMARY

Embodiments of the present disclosure relate to computer readable media, methods, and systems that enable a fully automated pipeline for generating personalized target content based on source content and a plurality of re-sizing options. In this regard, preexisting source content is selected and input into a content generation engine. The source content includes textual and image data. A focal point associated with the source content and at least one re-sizing option are selected. A focal point associated with target content, as well as the location of textual data associated with the target content are determined based on the selection of the source's focal point and re-sizing option. Target content is generated to conform to the at least one selected re-sizing option and the target content's determined focal point. The target content is then displayed for further modification.

Advantageously, the current disclosure reduces the cost and time inefficiencies associated with manual curation of target content based on source content. Further, in providing the generated target content within a user interface that offers a subset of non-native content editing tools, including but not limited to modification of textual and image data, the disclosed embodiments provide a content author with a less intimidating, more efficient user-friendly user interface in which to modify content. Providing a content author with a subset of non-native content editing tools is not routine or conventional.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present disclosure is described in detail below with reference to the attached drawing figures, wherein:

FIG. 1 is a schematic depiction of a system for generating target content based on source content and a plurality of re-sizing options, in accordance with embodiments of the present disclosure;

FIG. 2 is a depiction of a content generation engine, in accordance with embodiments of the present disclosure;

FIG. 3 is a schematic diagram showing an exemplary user interface illustrating source content selection, in accordance with some implementations of the present disclosure;

FIG. 4 is a schematic diagram showing an exemplary user interface illustrating focal point selection in association with selected source content, in accordance with some implementations of the present disclosure;

FIG. 5 is a schematic diagram showing an exemplary user interface illustrating re-sizing option selection in association with selected source content, in accordance with some implementations of the present disclosure;

FIG. 6 is a schematic diagram showing an exemplary user interface illustrating re-sized source content as generated target content, in accordance with some implementations of the present disclosure;

FIG. 7 is a schematic diagram showing an exemplary user interface illustrating textual data modification associated with target content, in accordance with some implementations of the present disclosure;

FIG. 8 is a schematic diagram showing an exemplary user interface illustrating image data modification associated with target content, in accordance with some implementations of the present disclosure;

FIG. 9A is flow diagram showing an exemplary method for generating target content based on source content and a plurality of re-sizing options, in accordance with some implementations of the present disclosure;

FIG. 9B is flow diagram showing an exemplary method for determining the focal point associated with target content and for determining the location of textual data within target content, in accordance with some implementations of the present disclosure; and

FIG. 10 is a depiction of a block diagram of an exemplary computing environment suitable for use in implementing embodiments of the present disclosure.

### DETAILED DESCRIPTION

### Overview

Content can be authored for various purposes, personalized for various viewers, and displayed in various arrangements. By way of a non-limiting example, content may include an advertisement for home improvement tools displayed as a horizontal banner advertisement on a sports-related webpage viewed on a desktop computer. Content may be targeted towards a marketing campaign for mobile devices. When such content is displayed on an educational-related webpage, via a tablet device, the content appears as a vertical banner advertisement. Content may be further targeted towards the promotion of medical services. When such content is displayed on a financial-related webpage, via a smartphone, the content appears as a square banner advertisement. In preparing such content, a content author may account for the substance (e.g., level of personalization, textual data, image data, and the like) of the content, the various width and height requirements of the chosen channels of distribution and/or destination webpage, and/or the intended target audience to which the content will be distributed. As can be appreciated, while examples of the present disclosure described herein relate to advertisements, promotions, and marketing materials, the present disclosure contemplates the generation of non-commercial related content.

Oftentimes, content that an author seeks to distribute already exists (e.g., preexisting source content) but in a size not suitable for all intended distribution channels. For example, an advertisement for home improvement tools may already exist. Such preexisting source content includes width and height dimensions. However, the dimensions of the source content may not conform to the width and height requirements of the author's chosen destination webpage(s) and/or channel(s) of distribution. In such a case, the author must manually re-size the preexisting advertisement to ensure it adheres to the various unique dimension requirements. Additionally and/or alternatively, the author may wish to create a variation of the source content (e.g., altering textual and/or image data). For example, a preexisting advertisement for home improvement tools may display power-tool image data accompanied with holiday sale textual data. An author may wish modify the textual data to reflect a different sale (e.g., a summertime sale) and/or may wish to update the image data to display gardening tools to ultimately reflect a summertime sale of gardening tools. To alter the textual and image data associated with the re-sized content (e.g., target content), an author would have to individually and manually update each re-sized advertisement with the updated textual and image data.

In some cases, modifications a content author desires to make in association with preexisting content involves the use of complicated, unapproachable, and/or nuanced editing tools within unfamiliar content editing software. In such cases, a content editing expert (e.g., graphic designer, and the like) familiar with such tools may be employed to accomplish such a content modification. The unavailability of content editing tools in an approachable, user-friendly user interface leading to the employment of expert content editors increases the cost and decreases efficiency of generating personalized content, slows the distribution of content, and leads to frustrated content authors.

In an effort to automate personalized content generation for distribution, one conventional approach using dynamic content publishing systems, such as the dynamic content publishing products provided by Adobe Systems of San Jose, Calif. In some cases, dynamic content publishing systems allow a content author to manipulate content, such as modifying the textual and image data of the content. In other cases, these publishing systems allow for scalability of modifications and a streamlined user interface. However, while these systems provide for batch editing and scalability, they may not provide re-sizing functionality, nor do they provide the ability to distribute the modified content to a destination webpage. In other words, no content delivery mechanism includes the automated generation of target content, via the re-sizing and/or modification of source content, combined with the automatic distribution of the target content within a plurality of distribution channels. If a content author attempted to distribute a modified advertisement to a destination webpage using existing solutions, the result would be broken advertisements, broken advertisement links, advertisements that do not conform to destination webpage dimension display requirements, and the slow delivery execution of the advertisement, all resulting in a poor user experience.

There have also been some efforts toward more efficiently re-sizing and modifying preexisting content by way of extensive training. Often, content editing software which content editors (e.g., graphic designers and the like) use to create initial content is often packaged in a complex, unapproachable, and nuanced user interface. In many cases, content authors are unfamiliar with such cumbersome content editing tools and user interfaces. As a result, content authors may be intimidated by such tools and user interfaces. For instance, content authors may be inefficient at using such tools and interfaces, and content authors may not achieve their desired target content results using such tools and interfaces due to their inability to navigate and effectually use them. To reduce such deficiencies, restrictions, and limitations, some developers of content editing tools invest considerable resources into training content authors how to efficiently navigate and use complex content editing tools and interfaces. However, while this technique may address immediate content author deficiencies, new features are continually added to content editing software, resulting in the need for continued training. This technique also does not solve the automatic re-sizing issue as, in many cases, content editing software does not provide automatic content re-sizing functionality.

Accordingly, embodiments described herein are directed to automatically generating target content based on source content. In this regard, embodiments described herein automatically generate content, also referred to herein as target content, using preexisting content, also referred to herein as source content, and a plurality of re-sizing options. Embodiments described herein further provide a mechanism for modifying the target content after its generation. In operation, target content can be generated based on receiving a selection that indicates the source content from which to generate the target content. The source content includes a width value and height value (e.g., attribute) associated with the width and height dimensions of the content, as well as other attributes. As noted above, the source content includes at least one of textual data and image data.

In embodiments, a focal point associated with the source content is selected, as well as at least one re-sizing option. By way of non-limiting example, a focal point associated with the source content may be selected (e.g., set or altered) by a user (e.g., content author, advertiser, marketer, etc.). Additionally and/or alternatively, a focal point also may be selected (e.g., set, altered, recommended, etc.) automatically by the system based on pre-processing of the source content and/or pre-processing of the image data and/or textual data associated with the source content. In this regard, once source content is selected the system can automatically select a focal point associated with the source content. A user may alter (e.g., change) the location of the focal point. Using at least one of the selected focal point and the at least one selected re-sizing option, a placement within the target content, of at least a portion of the textual data of the source content and at least a portion of the image data of the source content, is determined. Furthermore, using at least one of the selected focal point and the at least one selected re-sizing option, a focal point of the target content is determined. Based on upon these determinations, the target content is generated, wherein the target content includes a second width and height attribute based on the at least one selected re-sizing option. More specifically, the placement of the textual and image data associated with the target content is based on the determined focal point in association with the target content and the at least one selected re-sizing option.

In some embodiments, the generated target content is displayed, and in other embodiments, the generated target content can be displayed for further modification. Modifications of the generated target content can include editing various attributes associated with the target content such as, textual and image data. By way of non-limiting example, editing and/or updating of textual data can include modifications to the color, size, font, and/or alignment attributes of the textual data. Additionally and/or alternatively, by way of non-limiting example, editing and/or updating of the image data can include modifications replacing at least portions of the image data with alternative image data, and selection of a scaling attribute (e.g., automatically scale to fit).

In embodiments, generated target content may be delivered via various channels of distribution. Viewers and the like may view the delivered target content via a variety of mediums, including but not limited to digital and/or virtual reality. In this regard, and by way of non-limiting example, generating target content with height and width dimensions that conform to a ratio (e.g., flexible advertisement; flexible content) rather than fixed pixels can be beneficial if the target content is displayed in an immersive environment, such as virtual or augmented reality. In such an environment where pixel size may not be as relevant, while the height and width dimensions of the target content may conform to a 1:1 ratio, the target content may physically appear to be the size of a building.

In this regard, source content can be automatically re-sized based on a selection of at least one re-sizing option (e.g., fixed pixels; ratio), thereby generating target content that conforms to the width and height dimensions of a content author's chosen channel(s) of distribution and/or destination webpage. Advantageously, the current disclosure reduces the cost and time inefficiencies associated with manual curation of target content based on source content. Further, in providing the generated target content within a user interface that offers a subset of non-native content editing tools, including but not limited to modification of textual and image data, the disclosed technique supplies a content author with a less intimidating, more efficient user interface in which to modify content. Additionally, providing a user with a subset of non-native content editing tools as described herein is not routine or conventional.

### Definitions

Having briefly described an overview of aspects of the present disclosure, various terms used throughout this description are provided. Although more details regarding various terms are provided throughout this description, general descriptions of some terms are included below to provide a clearer understanding of the ideas disclosed herein:

Content—As used herein, the term “content” refers digital data that includes at least one of image data or textual data. In various embodiments, content may include audio data, video data, and the like. The image data included in content may be at least two-dimensional (2D) image data. As such, content is at least 2D content and includes at least a width attribute and a height attribute. The width attribute may be value for the spatial distance, or the number of pixels, associated with width dimension of the content. Likewise, the height attribute may be value for the spatial distance, or the number of pixels, associated with height dimension of the content. The textual data may include textual information, as well as font size, font style, and the like. The textual data may be associated with and/or positioned at a location within the 2D content. Likewise, the image data may be associated with and/or positioned at a location within the 2D content. Content may include a focal point. Content may include, but is not otherwise limited to digital visual advertisements, promotions, offerings, suggestions, or any other visual content. Thus, content may be referred to as digital content. Content may be layered content that includes a plurality of layers. At least one of the plurality of layers may be an editable layer. The one or more editable layers generally have various modifiable attributes such as textual and image data. Content may be encoded in any of various digital formats, structures, and/or encoding schemas.

Source Content—As used herein, the term “source content” includes content that is tailored with regard to viewers, target audiences, and/or potential customers. In the context of online marketing, source content is a digital advertisement, promotion, offering, suggestion, or the like tailored with regard to viewers, target audiences, and/or potential customers that is re-sized, modified, delivered, and consumed electronically. By way of non-limiting example, source content can include an advertisement authored in a content editing software program depicting home improvement tools, such as power tools or gardening tools. Textual data, such as text detailing a holiday or summertime sale may accompany the home improvement tool image data. By way of non-limiting example, source content may advertise, promote, or market products, goods, and/or services.

Target Content—As used herein, the term “target content” refers to a re-sized version of, or more than one re-sized version of, source content. By way of non-limiting example, given source content in the form of an advertisement for home improvement tools with an associated width and height dimension, a re-sized version of that advertisement associated with a different selected width and height dimension (e.g., fixed pixels; ratio) is target content. Additionally and/or alternatively, given that same piece of source content with an associated width and height dimension, more than one re-sized version of that advertisement associated with more than one selected width and height dimensions (e.g., fixed pixels; ratios) would be target content. Various attributes associated with the target content, include but not limited to textual and image data, are modifiable. By way of non-limiting example, target content may advertise, promote, or market products, goods, and/or services.

Focal Point—As used herein, the term “focal point” refers to a first region of image data located at a first location within content. The focal point of source content is the location at which the re-sized source content (e.g., the target content) is centered around. By way of non-limiting example, if an advertisement details a field of multi-colored flowers, including a red, white, yellow, and purple flower, and an advertiser selects the purple flower as the focal point, then the focal point of the re-sized source content will be the purple flower. By way of non-limiting example, focal point may be selected by a user (e.g, content author, etc.) or automatically selected by the system.

Textual Data—As used herein, the term “textual data” refers to phrases, words, sentences, and the like associated with source and target content. Generally, textual data can be modified (e.g., re-sized, re-positioned). By way of non-limiting example, if source or target content is a sale for home improvement tools, specifically a holiday sale for power tools, then the phrase, words, or sentence(s) detailing the sale is textual data.

Image Data—As used herein, the term “image data” refers to any digital data that encodes visual information. Image data may include background images, foreground images, and the like associated with source and target content. Generally, image data can be modified (e.g., re-sized, re-positioned, replaced with a different image). By way of non-limiting example, if source or target content is targeted towards a sale for home improvement tools, specifically a holiday sale for power tools, then the content may include image data that encodes one or more visual images detailing the sale, including the image or images of the power tools.

Distribution Channel—As used herein, the term “distribution channel” refers to any digital forum (e.g., website, application, platform, ecosystem, or the like) where source and/or target content may be delivered.

Destination Webpage—As used herein, the term “destination webpage” is a distribution channel that includes a third-party webpage to where target content is delivered. A destination webpage is offsite, meaning it is a third-party webpage not owned or hosted by the content author. By way of non-limiting example, a destination webpage may include any webpage on which an advertiser, marketer, or promoter wishes to promote target content. A destination webpage can include, by way of non-limiting example, the homepage of a personalized browser, the textbook webpage of an educational institution's website, the loan webpage of a financial institution's website, the shopping cart webpage of an online purchase and delivery service, or the FAQ section of a medical services website.

Re-sizing Option—As used herein, the term “re-sizing option” refers to a selectable option with an associated height and width value (e.g., dimension, pixel value). The height and width values of the selected at least one re-sizing option are the height and width values associated with generated target content. When more than one re-sizing option are selected, more than one target content are simultaneously generated, each conforming to a different selected re-sizing option. By way of non-limiting example, if a content author desires to generate a square-sized, a horizontal rectangle-sized, and a vertical rectangle-sized target content, the author may select a 200 by 200 pixel, a 300 by 600 pixel, and 970 by 250 pixel re-sizing options. In such a case, the first target content generated would conform to the 200 by 200 pixel dimension, the second target content generated would conform to the 300 by 600 pixel dimension, and the third target content generated would conform to the 970 by 250 pixel dimension. Further, and by way of non-limiting example, the height and width values (e.g., dimensions) of a re-sizing option can be represented in terms of fixed pixels or as a ratio, such as a ratio in accordance with the Interactive Advertising Bureau (IAB) Flexible Advertising guidelines. In this regard, target content can be a ratio (e.g., 1:1 (square); 8:1 (banner)) that can adjust (e.g., scale) to any screen with a given pixel dimension so long as the target content adheres to the given pixel dimensions' ratio.

Scaling Factor—As used herein, the term “scaling factor” refers to a value (e.g., ratio) that scales, or mathematically operates on, some quantity. To determine the location of the textual data associated with target content, a scaling factor is used. In operation, the scaling factor used to determine the location of the textual data associated with target content is a comparison between the width and height attributes associated with the selected source content and the selected width and height attributes associated with the at least one selected re-sizing option.

### Exemplary Content Generation Environment

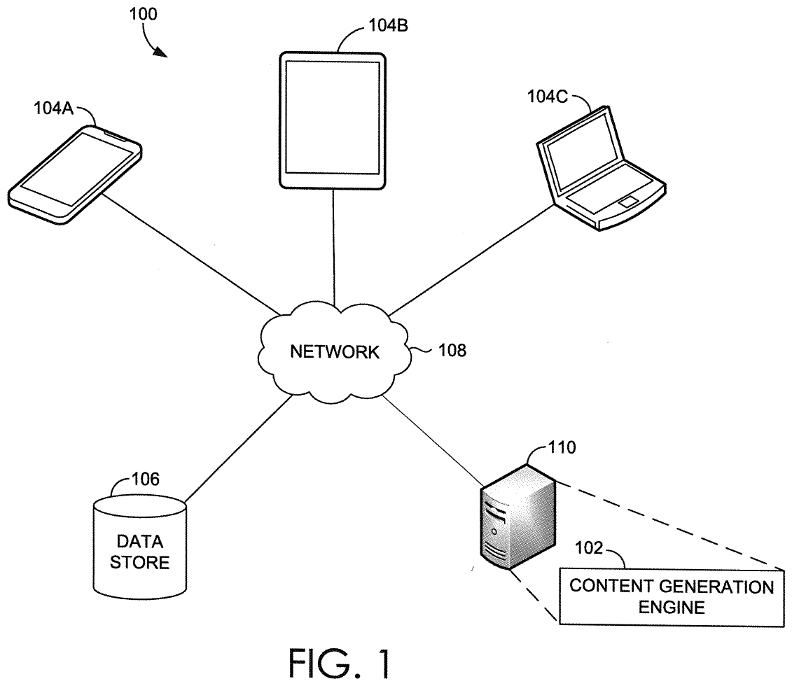

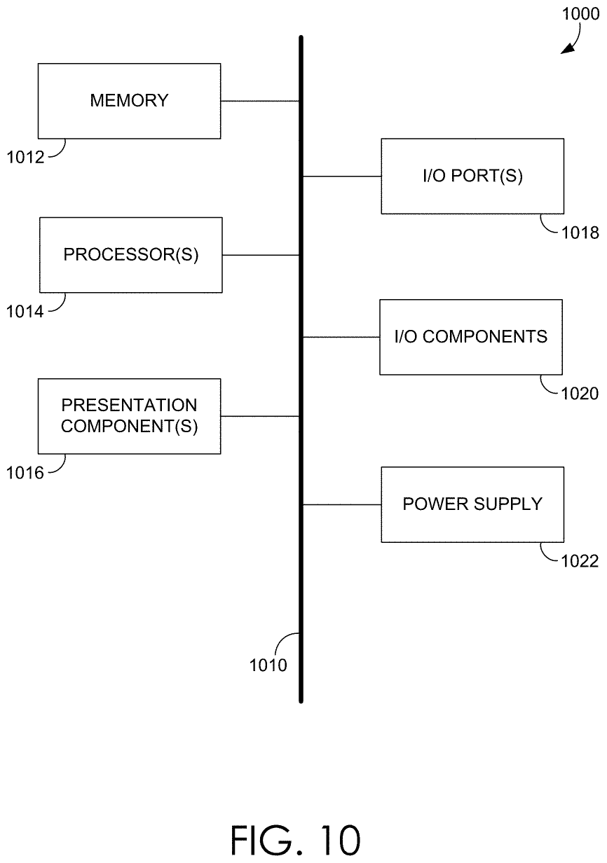

Turning now to FIG. 1, a schematic depiction is provided illustrating an exemplary system 100 in which some embodiments of the present disclosure may be employed. Among other components not shown, the environment 100 may include a content generation engine 102, a user device, such as user devices 104A, 104B, and 104C, a data store 106, and a distributed computing environment 110. Distributed computing environment 110 hosts content generation engine 102. It should be understood that the system 100 shown in FIG. 1 is an example of one suitable computing system. Any of the components shown in FIG. 1 may be implemented via any type of computing device, such as computing device 1000 described with reference to FIG. 10, for example. The components may communicate with each other via one or more networks 108, which may include, without limitation, one or more local area networks (LANs) and/or wide area networks (WANs). Such networking environments are commonplace in offices, enterprise-wide computer networks, intranets, and the Internet.

It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Generally, system 100 facilitates target content generation based on source content and a plurality of re-sizing options. At a high-level, target content is generated using preexisting source content with associated width and height dimensions, as well as associated textual and image data. Using a selected focal point associated with the source content and at least one re-sizing option associated with the source content, target content is generated.

By way of non-limiting example, assume a content author (e.g., user), such as an advertiser, wishes to update an existing advertisement for home improvement tools (e.g., a holiday sale of power tools) to reflect a new sale (e.g., a springtime sale of gardening tools), as well as re-size the advertisement to ensure distribution via various channels and/or to various destination webpages. Assume too that each of the various channels of distribution and/or destination webpages require a unique width and height dimension for proper display to potential customers. In such as case, the advertiser selects the source content associated with the holiday sale of power tools they wish to re-size and modify. Upon selecting the source content, the advertiser may select the focal point associated with the source content and the at least one re-sizing option that conforms to the width and height requirement of the desired channel of distribution and/or designation webpage. Additionally and/or alternatively, the system may automatically select the focal point associated with the source content and display the focal point to the advertiser for modification. A location within the target content for the focal point of the target content is determined based on the width and height attributes of the source content, the width and height selections for the target content, and the selected focal point associated with the source content. Target content is generated that conforms to the selected width and height requirements (e.g., fixed pixels; ratios), wherein the textual data associated with the source content is repositioned in relation to the focal point associated with the target content, and the power tool image data remained in the background. The target content is then displayed to the advertiser, wherein the advertiser may select additional image data associated with gardening tools to replace the image data associated with power tools, to finalize the target content.

Returning to FIG. 1, in operation, a user device, such as user devices 104A-104C, can access the content generation engine 102, hosted by distributed computing environment 110 (e.g., a server), over a network 108 (e.g., a LAN or the Internet). For instance, a user device, such as user devices 104A-104C may provide and/or receive data from the content generation engine 102 via the network 108. Network 108 may include multiple networks, or a network of networks, but is shown in simple form so as not to obscure aspects of the present disclosure. By way of example non-limiting, network 108 can include one or more wide area networks (WANs), one or more local area networks (LANs), one or more public networks, such as the Internet, and/or one or more private networks. Networking environments are commonplace in offices, enterprise-wide computer networks, intranets, and the Internet. Accordingly, network 108 is not described in significant detail.

A user device, such as user devices 104A-104C, may be any computing device that is capable of facilitating an author to select source content. Source content, as described herein, generally refers to a digital advertisement, promotion, offering, suggestion, or the like tailored with regard to viewers, target audiences, and/or potential customers. In the context of online marketing, source content is a digital advertisement, promotion, offering, suggestion, or the like tailored with regard to viewers, target audiences, and/or potential customers that is re-sized, modified, delivered, and consumed electronically. Source content can be re-sized and modified to create target content. For example, a user may provide source content to the content generation engine 102 via a browser or application installed on a user device, such as user devices 104A-104C. Further, any type of user interface may be used to input such source content. In some cases, a user may input source content, for example, by copying/pasting source content or selecting the source content from a data store, such as data store 106.

In response to providing source content, a user device, such as user devices 104A-104C, may generate and present target content, or portion thereof. In this regard, target content generated in response to the user-provided source content can be provided to the user device for display to the user (e.g., via a browser or application installed on a user device, such as user devices 104A-104C).

In some cases a user device, such as user devices 104A-104C, accesses the content generation engine 102 via a web browser, terminal, or standalone PC application operable on the user device. A user device, such as user devices 104A-104C, might be operated by an administrator, which may be an individual or set of individuals that manages content associated with an advertising campaign, a website, an application, or the like. For instance, a user may be any individual, such as a content author, advertiser, marketer, or promoter, associated with an entity (e.g., business) advertising the content (e.g., via the Internet). While only user devices 104A-104C are illustrated in FIG. 1, multiple other user devices associated with any number of users may be utilized to carry out embodiments described herein. A user device, such as user devices 104A-104C, may take on a variety of forms, such as a personal computer (PC), a laptop computer, a mobile phone, a tablet computer, a wearable computer, a personal digital assistant (PDA), an MP3 player, a global positioning system (GPS) device, a video player, a digital video recorder (DVR), a cable box, a set-top box, a handheld communications device, a smart phone, a smart watch, a workstation, any combination of these delineated devices, or any other suitable device. Further, a user device, such as user devices 104A-104C, may include one or more processors, and one or more computer-readable media. The computer-readable media may include computer-readable instructions executable by the one or more processors.

In some cases, a user of distributed computing environment 110 may employ one or more user interfaces via a web browser, terminal, or standalone PC application operable on the distributed computing environment to control and/or operate content generation engine 102 to generate target content. Users of distributed computing environment 110 may further control and/or operate content generation engine 102 to distribute generated target content to a destination webpage that may be displayed on a user device, such as user devices 104A-104C. Distributed computing environment 110 may be operated by an administrator, which may be an individual or set of individuals that manages content associated with an advertising campaign, a website, an application, or the like. For instance, a user may be any individual, such as a content author, advertiser, marketer, or promoter, associated with an entity (e.g., business) advertising the content (e.g., via the Internet). While only distributed computing environment 110 is illustrated in FIG. 1, multiple other distributed computing devices associated with any number of users may be utilized to carry out embodiments described herein.

A distributed computing environment, such as distributed computing environment 110, may take on a variety of forms such as a server, personal computer (PC), a laptop computer, a mobile phone, a tablet computer, a wearable computer, a personal digital assistant (PDA), an MP3 player, a global positioning system (GPS) device, a video player, a digital video recorder (DVR), a cable box, a set-top box, a handheld communications device, a smart phone, a smart watch, a workstation, any combination of these delineated devices, or any other suitable device. Further, a distributed computing environment, such as distributed computing environment 110, may include one or more processors, and one or more computer-readable media. The computer-readable media may include computer-readable instructions executable by the one or more processors.

The data store 106 includes, among other data, source content data that may contain author-desired information used to facilitate target content generation. As described in more detail below, the data store 106 may include source content data including advertisement, promotions, and marketing materials, or the like, and/or metadata associate therewith. Additionally and/or alternatively, data store 106 may also include additional information, such as textual and image data, and the like, used to modify source and target content. Such content data may be stored in the data store 106 and accessible to any component of the system 100. The data store may also be updated at any time, including an increase or decrease in the amount of source content data or an increase or decrease in the amount content in the data store that is not relevant to the author-selected source content or that is relevant to source and target content modification. Further, content contained within data store 106 may be changed or updated at any time.

The content generation engine 102 is generally configured to generate target content from preexisting source content and, thereafter, may cause display of the target content for further modification. In particular, the content generation engine 102 can collect source content, receive a focal point selection associated with the source content, receive at least one re-sizing option, determine a focal point associated with the target content, determine a location for textual data associated with the target content, generate target content, and cause display of the target content for modification. In implementation, and at a high-level, the content generation engine 102 collects source content with a first width and height attribute to use as a basis to generate target content. In particular, the content generation engine 102 generates the target content by receiving a focal point selection associated with the source content selection and at least one re-sizing option associated with the source content. The content generation engine 102 then determines a focal point associated with the target content based on the first width and height attribute associated with the source content, the focal point selection associated with the source content, and the at least one re-sizing option associated with the source content. The location of the textual data within the target content is also determined. Target content is then generated and presented for further modification before distribution.

Although FIG. 1 illustrates a distributed system in which content generation engine 102 is located on a server remote from user devices 104A-104C (e.g., distributed computing environment 110), in other embodiments, content generation engine 102 can be located on, executed by, or otherwise installed on a user device, such as user devices 104A-104C. Additionally and/or alternatively, in other embodiments, at least one component of content generation engine 102 can be located on a user device, such as user devices 104A-104C.

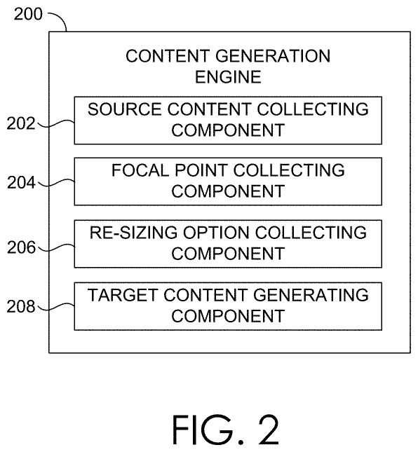

An exemplary content generation engine is provided in FIG. 2. As shown in FIG. 2, a content generation engine 200 includes source content collecting component 202, focal point collecting component 204, re-sizing option collecting component 206, and target content generating component 208. The source content collecting component 202 is generally configured to collect source content used as a basis to generate target content. Focal point collecting component 204 is generally configured to collect the focal point selection associated with the source content. The re-sizing option collecting component 206 is generally configured to collect at least one re-sizing option selected by a user associated with the source content. The target content generating component 208 is generally configured to generate target content based on the selected source content, the selected focal point associated with the source content, and the selected at least one re-sizing option associated with the source content. Advantageously, the content generation engine 200 can automatically re-size source content into target content which reduces cost and time inefficiencies associated with manual curation of target content based on source content. Further, in providing the generated target content within a user interface that offers a subset of content editing tools, including but not limited to modification of textual and image data, content generation engine 200 supplies a content author with a less intimidating, more efficient user interface (a combination of a subset of non-native content editing tools in an approachable, efficient user interface that is not convention or well-known) in which to modify content.

Although illustrated as separate components of the content generation engine 200, any number of components can be used to perform the functionality described herein. Further, although illustrated as being a part of a content generation engine, the components can be distributed via any number of devices. By way of non-limiting example, a source content collecting component can be provided via one device (e.g., a user device, such as user devices 104A-104C of FIG. 1), server, or cluster of servers, while a focal point collecting component can be provided via another device, server, or cluster of servers. The components identified herein are merely set out as examples to simplify or clarify the discussion of functionality. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more components may be carried out by hardware, firmware, and/or software. For instance, various functions may be carried out by a processor executing instructions stored in memory.

As described, the source content collecting component 202 is generally configured to collect source content, for example, input by a user (e.g., content author), and used as a basis to generate target content. As described, source content can be a digital advertisement, promotion, offering, suggestion, or the like tailored with regard to viewers, target audiences, and/or potential customers. In the context of online marketing, source content is a digital advertisement, promotion, offering, suggestion, or the like tailored with regard to viewers, target audiences, and/or potential customers that is re-sized, modified, delivered, and consumed electronically.

Source content may be collected or obtained by source content collecting component 202 in any manner. In some cases, source content is provided by a user of the content generation engine, such as an advertiser, promoter, and/or marketer. In this regard, an advertiser or set of advertisers might select or input source content, for example, via a graphical user interface accessible by way of an application on a user device. As an example, a user might select source content via a user device, such as user devices 104A-104C of FIG. 1, which is connected to the network 108. For instance, an advertiser might select, for example, an advertisement associated with a holiday sale of home improvement tools with corresponding textual and image data as the source content from which a content generation engine, such as content generation engine 102 of FIG. 1, generates target content.

The focal point collecting component 204 is generally configured to collect the focal point selection associated with selected source content. As described herein, a focal point refers to a first region of image data located at a first location within selected source content. It is the location at which the re-sized source content (e.g., the target content) is centered around. By way of non-limiting example, assume an author selected source content associated with a holiday sale for power tools, wherein the image data depicted a circular saw, a jigsaw, a table saw, a cordless drill, and an impact wrench. Also assume the author desired to have the table saw be the focal point of the target content. The author may select the image data location associated with the table saw to ensure the image data location associated with the table saw is the focal point of the target content.

The re-sizing option collecting component 206 is generally configured to collect the at least one re-sizing option selected by a user. That is, the re-sizing option collecting component 206 collects the at least one width and height dimension into which the content generation engine 200 will re-size the source content to generate target content that conforms to the at least on width and height dimension.

The target content generating component 208 is generally configured to generate target content based on selected source content, a selected focal point associated with the source content, and a selected at least one re-sizing option associated with the selected source content. In particular, once a user selects source content, selects a focal point associated with the source content, and selects at least one re-sizing option associated with the source content, target content generating component 208 determines a focal point of the target content. Determining a focal point of the target content is based on the width and height dimensions (e.g., attributes) associated with the source content, the at least one width and height dimension associated with the selected at least one re-sizing option, and the location of the focal point selection associated with the source content.

Target content generating component 208 further determines a second location within the target content at which textual data will be located. The second location determination is based on the determined focal point of the target content, a size attribute of the textual data associated with the source content and a size attribute of the textual data associated with the target content. Target content generating component 208 generates the target content, wherein the target content includes a second width and height dimension (e.g., attribute), image data located at the determined focal point of the target content, textual data located at the determined second location, and at least one editable layer.

In operation, to determine the first location within the target content at which the first region of image data resides, target content generating component 208 generates a width scaling factor based on a comparison between the first width attribute associated with the selected source content and the selected second width attribute associated with the at least one selected re-sizing option. It also generates a height scaling factor based on a comparison between the first height attribute associated with the selected source content and the selected second height attribute associated with the at least one selected re-sizing option.

As can be appreciated, target content generating component 208 can generate more than one target content. The quantity of re-sized source content (e.g., target content) target content generating component 208 generates depends on the number of re-sizing options selected. In operation, and by way of non-limiting example, if a user were to select a first re-sizing option and a second re-sizing option, target content generating component 208 would output a second target content associated with the second selected re-sizing option, in addition to the first target content associated with the first selected re-sizing option. The second target content would have an associated width and height attribute corresponding to the width and height in association with the second selected re-sizing option. Target content generating component 208 would generate the second target content to include image data and textual data sized and located in sizes and at locations determined in the same manner the image and textual data size and location were determined for the first target content. As can be appreciated, when more than one re-sizing option is selected, target content generating component 208 can generate and output target content that conforms to the selected re-sizing options in various ways, including but not limited to sequentially and simultaneously.

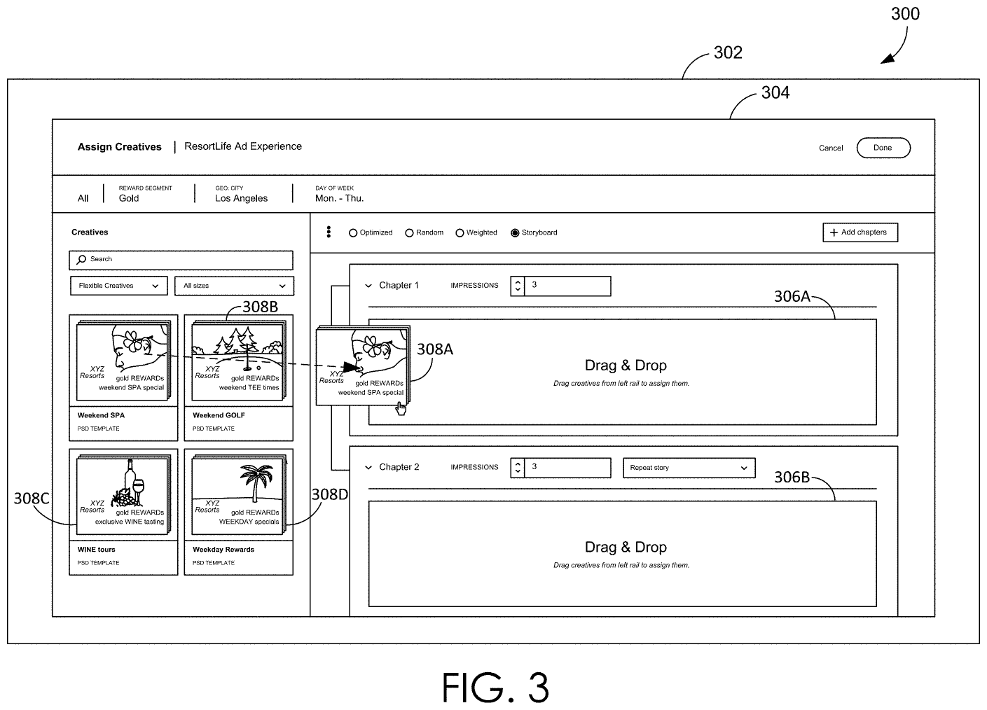

Now turning to FIG. 3, a schematic diagram showing an exemplary user interface illustrating source content selection by a user, designated generally as user environment 300. User environment 300 is displayed via a display device 302. For instance, user environment 300 may be displayed on a display device of a user device. The display device 302 is configured to show a graphical user interface 304. By way of non-limiting example, display devices that are suitable for displaying a graphical user interface, such as graphical user interface 304, include a computer monitor, a projector, a television, a monitor on a laptop computer, a display on a PDA, and a display on a mobile phone, i.e., a user device. It should be noted that any application or operating system utilizing application windows or the equivalent thereof provides a suitable operating environment for practicing the present disclosure.

The graphical user interface 304 includes a source content interactive element, such as source content interactive elements 306A-306B, and source content, such as source content 308A-308D. A source content interactive element, such as source content interactive elements 306A-306B, is configured to retain source content selected by a user. A source content interactive element, such as source content interactive elements 306A-306B, can take many forms. By way of non-limiting example, a source content interactive element can be a drag and drop box, wherein a user drags selected source content and drops it into a drag and drop box. Once a user drops source content into the drag and drop box, the user may select at least one re-sizing option from which the disclosed technique may generate target content.

The graphical user interface 304 further includes source content, such as source content 308A-308D. As described herein, source content refers to a digital advertisement, promotion, offering, suggestion, or the like tailored with regard to viewers, target audiences, and/or potential customers. In the context of online marketing, source content is a digital advertisement, promotion, offering, suggestion, or the like tailored with regard to viewers, target audiences, and/or potential customers that is re-sized, modified, delivered, and consumed electronically. In operation, source content, such as source content 308A-308D that appears in graphical user interface 304 may be stored in a data store, such as data store 106 of FIG. 1. A user can select one or more source content and drag and drop the source content into a source content interactive element to be used as a basis to generate target content.

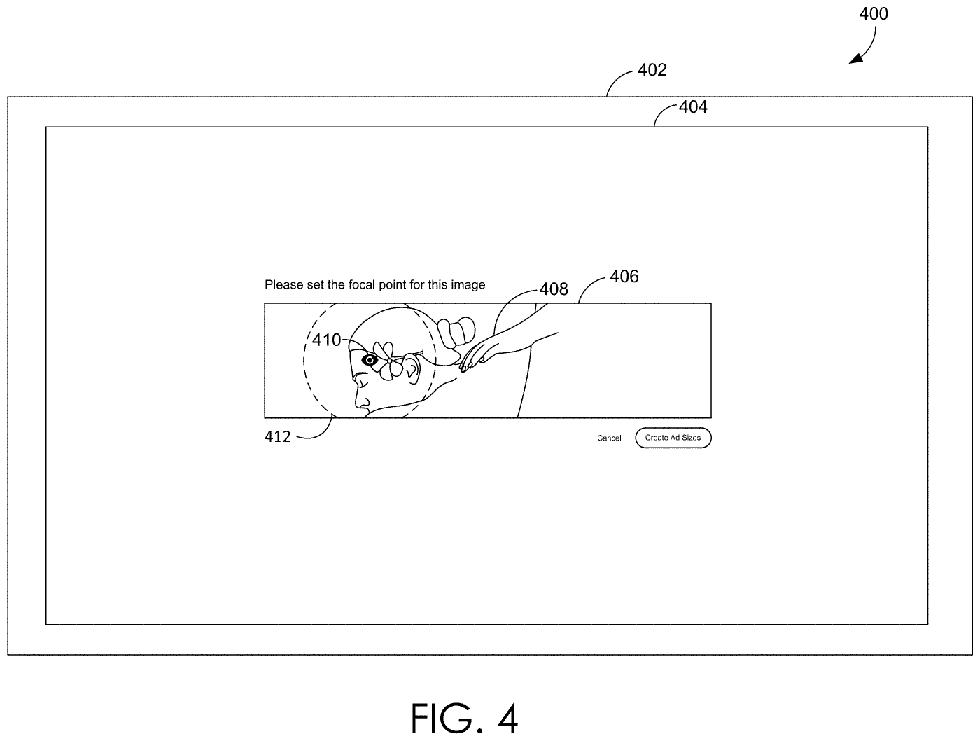

Now turning to FIG. 4, a schematic diagram showing an exemplary user interface illustrating focal point selection by a user, designated generally as user environment 400. User environment 400 includes a display device 402. The display device 402 is configured to show a graphical user interface 404. By way of non-limiting example, display devices that are suitable for displaying a graphical user interface, such as graphical user interface 404, include a computer monitor, a projector, a television, a monitor on a laptop computer, a display on a PDA, and a display on a mobile phone. It should be noted that any application or operating system utilizing application windows or the equivalent thereof provides a suitable operating environment for practicing the present disclosure.

The graphical user interface 404 includes a focal point interactive element 406, selected source content 408, a selected focal point 410, and a focal point region 412. Focal point interactive element 406 is configured to display selected source content contained within a source content interactive element, such as source content interactive elements 306A-306B of FIG. 3, during focal point selection. In operation, once a user has selected source content and moved it to the source content interactive element, a focal point interactive element, such as focal point interactive element 406, appears. The focal point interactive element 406 contains the source content, such as source content 408, enabling the user to select a focal point, such as focal point 410 with an associated focal point region 412, of the selected source content 408. As described, a focal point refers to a first region of image data located at a first location within selected source content. The focal point of source content is the location at which the re-sized source content (e.g., the target content) is centered around. The source content's focal potent may map to a specific region of the source content's image data. When generating target content via automatic re-sizing of the source content, the region of the source content's image data mapped to the source content's focal point may be similarly mapped to the target content's focal point. In operation and by way of non-limiting example, focal point 410 and its accompanying focal point region 412 is the image data location around which the content author wishes the target content to center.

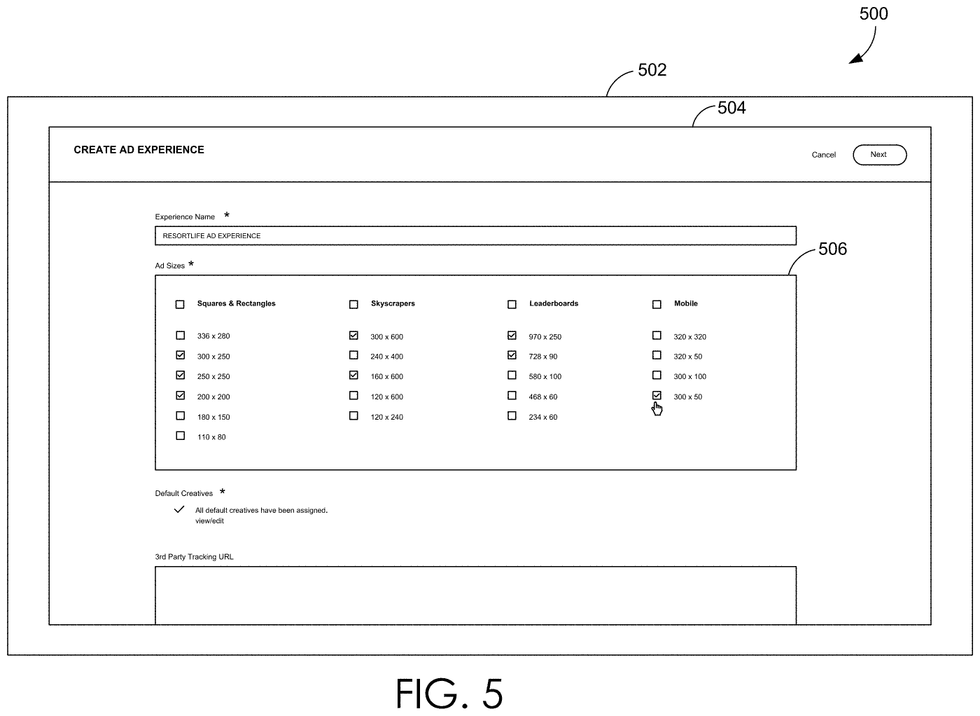

Now turning to FIG. 5, a schematic diagram showing an exemplary user interface illustrating re-sizing option selection in association with selected source content, designated generally as user environment 500. User environment 500 includes a display device 502. The display device 502 is configured to show a graphical user interface 504. By way of non-limiting example, display devices that are suitable for displaying a graphical user interface, such as graphical user interface 504, include a computer monitor, a projector, a television, a monitor on a laptop computer, a display on a PDA, and a display on a mobile phone. It should be noted that any application or operating system utilizing application windows or the equivalent thereof provides a suitable operating environment for practicing the present disclosure. The graphical user interface 504 includes re-sizing option interactive element 506. Re-sizing option interactive element 506 is configured to display at least one re-sizing option for a user to select, and then retain the user-selected at least one re-sizing option used by a content generating engine, such as content generating engine 102 of FIG. 1, as a basis to generate target content.

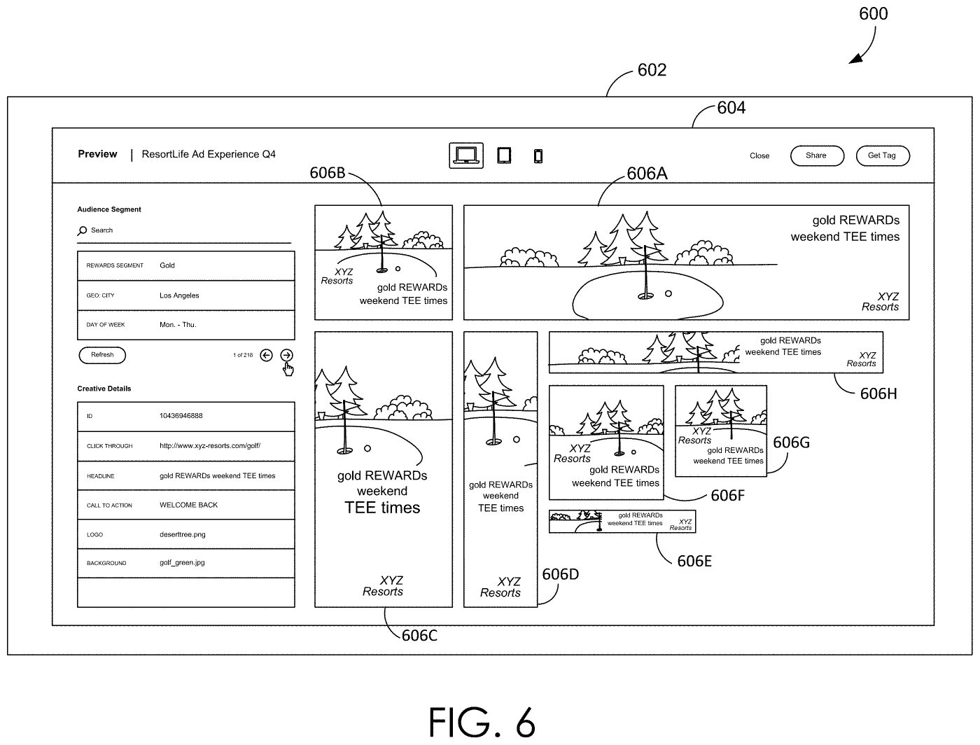

Now turning to FIG. 6, a schematic diagram showing an exemplary user interface illustrating re-sized source content as generated target content, designated generally as user environment 600. User environment 600 includes a display device 602. The display device 602 is configured to show a graphical user interface 604. By way of non-limiting example, display devices that are suitable for displaying a graphical user interface, such as graphical user interface 604, include a computer monitor, a projector, a television, a monitor on a laptop computer, a display on a PDA, and a display on a mobile phone. It should be noted that any application or operating system utilizing application windows or the equivalent thereof provides a suitable operating environment for practicing the present disclosure.

The graphical user interface 604 further includes target content, such as target content 606A-606H. As described herein, target content refers to a re-sized version of, or many re-sized versions of, source content. In operation, the target content, such as target content 606A-606H that appears in graphical user interface 604 has associated width and height dimensions that correspond with the at least one selected re-sizing option, such as re-sizing options selected in re-sizing option interactive element 506 of FIG. 5. The target content generated that correspond to the various at least one re-sizing options may have textual data located at a determined location and may be centered around a determined focal point.

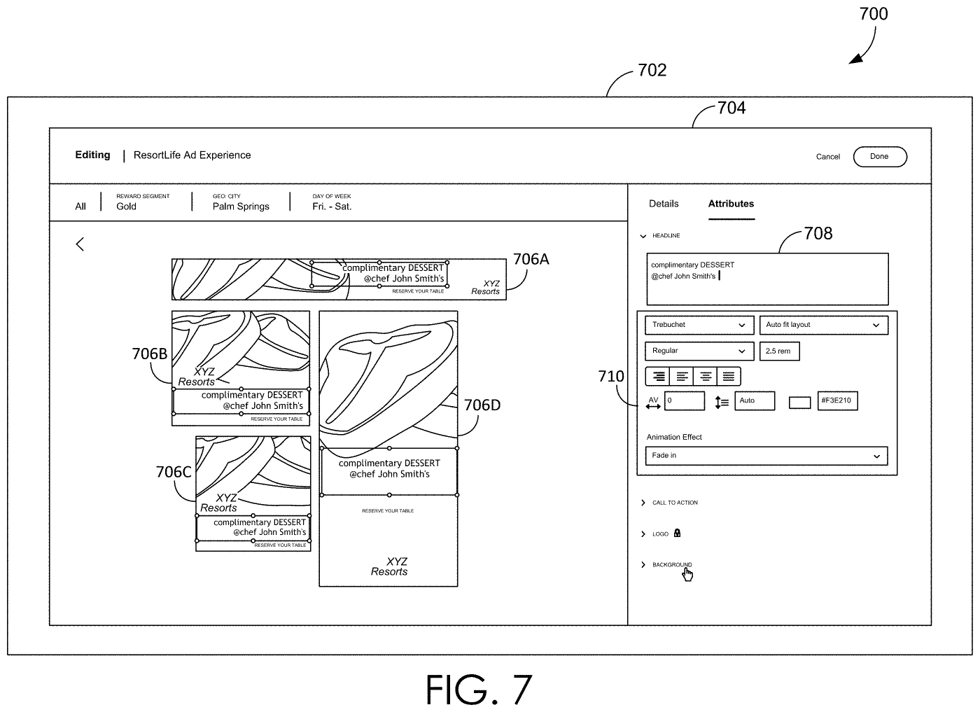

Now turning to FIG. 7, a schematic diagram showing an exemplary user interface illustrating textual data modification associated with target content, designated generally as user environment 700. User environment 700 includes a display device 702. The display device 702 is configured to show a graphical user interface 704. By way of non-limiting example, display devices that are suitable for displaying a graphical user interface, such as graphical user interface 704, include a computer monitor, a projector, a television, a monitor on a laptop computer, a display on a PDA, and a display on a mobile phone. It should be noted that any application or operating system utilizing application windows or the equivalent thereof provides a suitable operating environment for practicing the present disclosure.

The graphical user interface 704 further includes target content, such as target content 706A-706D. As described herein, target content refers to a re-sized version of, or many re-sized versions of, source content. The graphical user interface 704 further includes a textual data interactive element 708. A textual data interactive element 708 is configured to enable a user to modify textual data associated with target content. In operation, the target content, such as target content 706A-706D, that appears in graphical user interface 704 has associated modifiable textual data located in various locations determined as described herein. By way of non-limiting example, a user can enter different textual data in textual data interactive element 708 to modify the textual data associated with the target content, such as target content 706A-706D. More specifically, if the textual data associated with target content 706A-706D recited “chef Sebastian's exquisite FRENCH dining” and a content author wished to modify the content to recite “complimentary DESSERT @chef John Smith's”, the content author would input the desired textual data into textual data interactive element 708 and the textual data associated with target content 706A-706D would update to reflect the textual data input into textual data interactive element 708. As can be appreciated, a user may modify textual data of a single target content using textual data interactive element 708, or a user can simultaneously modify the textual data associated with more than one target content using textual data interactive element 708.

The graphical user interface 704 further includes textual data attribute interactive element 710. Textual data attribute interactive element 710 is configured to enable a user to modify aspects of the textual data other than the text itself. As described, and by way of non-limiting example, modifiable attributes of textual data associated with target content may include font, color, size, alignment, animation effect, and the like. As can be appreciated, a user may modify at least one attribute of textual data associated with a single target content using textual data attribute interactive element 710, or a user can simultaneously modify at least one attribute of textual data associated with more than one target content using textual data attribute interactive element 710.

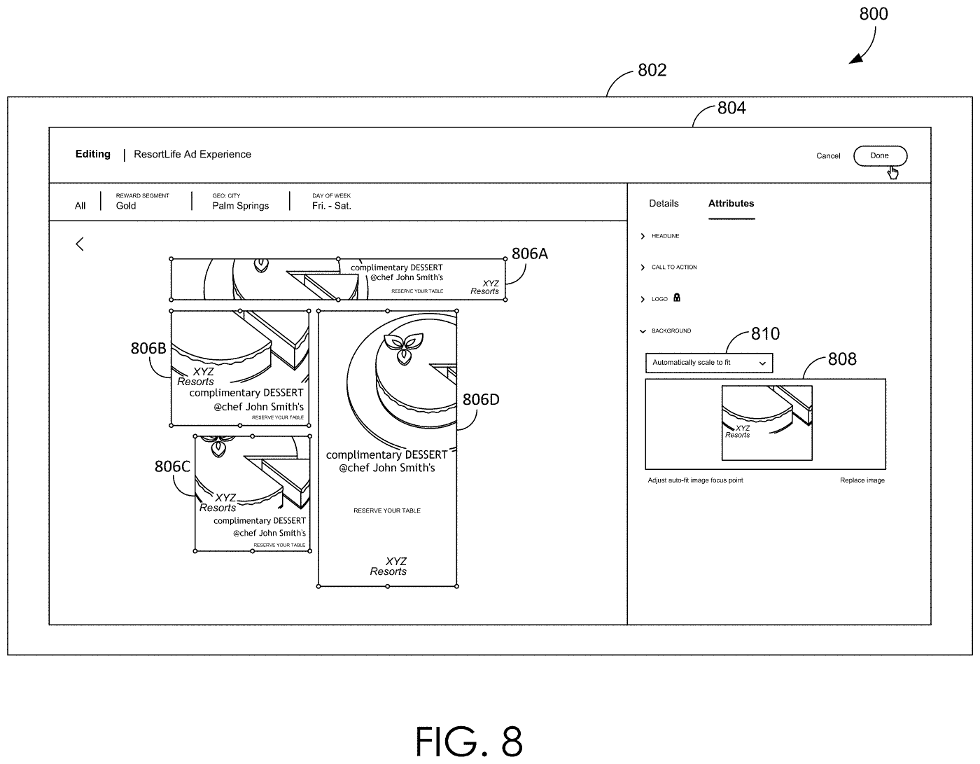

Now turning to FIG. 8, a schematic diagram showing an exemplary user interface illustrating image data modification associated with target content, designated generally as user environment 800. User environment 800 includes a display device 802. The display device 802 is configured to show a graphical user interface 804. By way of non-limiting example, display devices that are suitable for displaying a graphical user interface, such as graphical user interface 804, include a computer monitor, a projector, a television, a monitor on a laptop computer, a display on a PDA, and a display on a mobile phone. It should be noted that any application or operating system utilizing application windows or the equivalent thereof provides a suitable operating environment for practicing the present disclosure.

The graphical user interface 804 further includes target content, such as target content 806A-806D. As described herein, target content refers to a re-sized version of, or many re-sized versions of, source content. The graphical user interface 804 further includes an image data interactive element 808. An image data interactive element 808 is configured to enable a user to modify image data associated with target content. In operation, the target content, such as target content 806A-806D that appears in graphical user interface 804 has associated modifiable image data. By way of non-limiting example, a user can input a different image data into image data interactive element 808 to modify the image data associated with the target content, such as target content 806A-806D. More specifically, if the image data associated with target content 806A-806D was of a steak dinner, and a content author wished to modify the content to reflect a cheesecake dessert, the content author would input the desired image data into image data interactive element 808 and the image data associated with target content 806A-806D would update to reflect the image data input into image data interactive element 808. As can be appreciated, a user may modify image data of a single target content using image data interactive element 808, or a user can simultaneously modify the image data associated with more than one target content using image data interactive element 808.

The graphical user interface 804 further includes image data attribute interactive element 810. Image data attribute interactive element 810 is configured to enable a user to modify aspects of the image data other than the image itself. As described, and by way of non-limiting example, modifiable attributes of image data associated with target content may include the fit of the textual data to the target content, such as scale to fit. As can be appreciated, there exist various other modifiable image data attributes contemplated by the present disclosure. As can be further appreciated, a user may modify at least one attribute of image data associated with a single target content using image data attribute interactive element 810, or a user can simultaneously modify at least one attribute of image data associated with more than one target content using image data attribute interactive element 810.

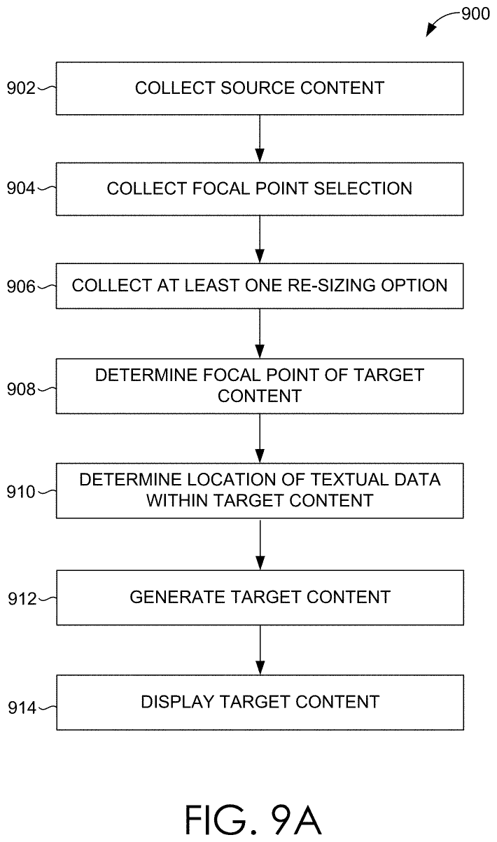

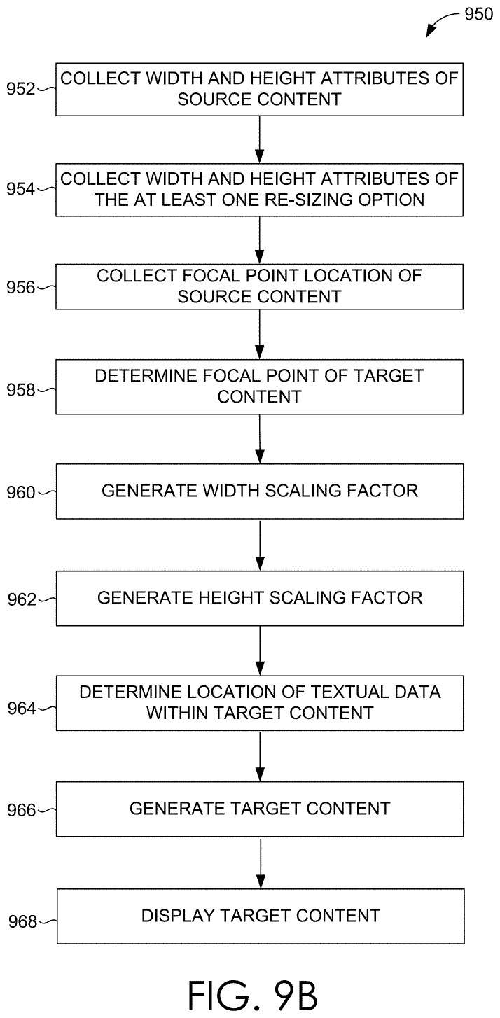

Now turning to FIG. 9A, a flow chart diagram is illustrated showing an exemplary method 900 for generating target content based on source content and a plurality of re-sizing options, in accordance with embodiments of the present disclosure. In embodiments, method 900 is performed by a content generation engine, such as content generation engine 200 of FIG. 2. Initially, and as indicated at block 902, source content is collected. At block 904, a focal point associated with the source content and selected by a user is collected. Referring to block 906, at least one re-sizing option selected by a user is collected. At block 908, a focal point of the target content is determined. As described, the focal point associated with the target content is determined based on the width and height dimensions (e.g., attributes) associated with the source content, the at least one width and height dimension associated with the selected at least one re-sizing option, and the location of the focal point selection associated with the source content. At block 910, the location of the textual data associated with the target content is determined. As described, the location at which the textual data associated with the target content is based on the determined focal point of the target content, a size attribute of the textual data associated with the source content, and a size attribute of the textual data associated with the target content. At block 912, the target content is generated. At block 914, the target content is displayed. As described herein, in some embodiments, target content is displayed for further modification, including but not limited to modification of image and textual data associated with the target content.

Now turning to FIG. 9B, a flow chart diagram is illustrated showing an exemplary method 950 for determining the focal point associated with target content and for determining the location of textual data within target content, in accordance with embodiments of the present disclosure. In embodiments, method 950 is performed by a content generation engine, such as content generation engine 200 of FIG. 2. Initially, and as indicated at block 952, width and height attributes associated with the selected source content are collected. At block 954, width and height attributes of the at least one re-sizing option are collected. At block 956, the location of the focal point associated with the source content is collected. Referring to block 958, the focal point associated with the target content is determined. As described, determining a focal point associated with target content is based on the width and height attributes of the source content, the width and height attributes of the at least one selected re-sizing option, and the selected focal point associated with the source content.

Referring now to block 960, a width scaling factor is generated wherein the generated width scaling factor is based on a comparison between the width attribute associated with the source content and the width and associated with the at least one selected re-sizing option. At block 962, a height scaling factor is generated wherein the generated height scaling factor is based on a comparison between the height attribute associated with the source content and the height and associated with the at least one selected re-sizing option. At block 964, the location of the textual data within the target content is determined. At block 966, the target content is generated. At block 968, the target content is displayed.

Having described embodiments of the present disclosure, an exemplary operating environment in which embodiments of the present disclosure may be implemented is described below in order to provide a general context for various aspects of the present disclosure. Referring initially to FIG. 10 in particular, an exemplary operating environment for implementing embodiments of the present disclosure is shown and designated generally as computing device 100. Computing device 1000 is but one example of a suitable computing environment and is not intended to suggest any limitation as to the scope of use or functionality of the disclosure. Neither should the computing device 1000 be interpreted as having any dependency or requirement relating to any one or combination of components illustrated.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

With reference to FIG. 10, computing device 1000 includes a bus 1010 that directly or indirectly couples the following devices: memory 1012, one or more processors 1014, one or more presentation components 1016, input/output (I/O) ports 1018, input/output components 1020, and an illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 10 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer-storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. The I/O components 1020 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be equipped with depth cameras, such as stereoscopic camera systems, infrared camera systems, RGB camera systems, touchscreen technology, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising.” In addition, words such as “a” and “an,” unless otherwise indicated to the contrary, include the plural as well as the singular. Thus, for example, the requirement of “a feature” is satisfied when one or more features are present. Also, the term “or” includes the conjunctive, the disjunctive and both (a or b thus includes either a or b, as well as a and b).

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more non-transitory computer storage media storing computer-useable instructions that, when executed by one or more computing devices, causes the one or more computing devices to perform operations for providing target content based on source content and a plurality of re-sizing options, the operations comprising:
receiving, via a user interface, a first selection that indicates the source content, wherein the indicated source content includes a first width attribute, a first height attribute, image data, and textual data located at a second location within the source content;
receiving, via the user interface, a second selection that indicates a focal point of the source content, wherein the focal point of the source content corresponds to a first region of the image data that is located at a first location within the source content;
receiving, via the user interface, a third selection that indicates a first re-sizing option of the plurality of re-sizing options, wherein the first re-sizing option is associated with a second width attribute and a second height attribute;
determining a focal point of the target content based on the first width and the first height attributes of the source content, the second width and the second height attributes associated with the first re-sizing option, and the first location of the source content;
determining a second location within the target content based on the focal point of the target content, the second location within the source content, and the textual data, wherein the textual data is located at the second location within the target content;
generating the target content, wherein the target content includes the second width attribute, the second height attribute, the first region of the image data located at a first location within the target content, and the textual data located at the second location within the target content; and
causing display, within the user interface, of the target content.

2. The one or more computer storage media of claim 1, wherein generating the target content comprises including an editable layer of the source content in the target content.

3. The one or more computer storage media of claim 1, the operations further comprising:
generating a width scaling factor based on a comparison between the first width attribute and the second width attribute;
generating a height scaling factor based on a comparison between the first height attribute and the second height attribute; and
determining the first location within the target content based on the width scaling factor and the height scaling factor.

4. The one or more computer storage media of claim 1, wherein the textual data includes an association with a first size attribute and the operations further comprise:
determining a second size attribute based the first width and height attributes of the source content, the second width and height attributes associated with the first re-sizing option, and the second location of the target content;
updating the textual data to include an association with the determined second size attribute;
generating the target content, wherein the updated textual data is located at the second location within the target content; and
causing display, within the user interface, of the target content such that the updated textual data located at the second location with the target content is displayed based on the second size attribute.

5. The one or more computer storage media of claim 1, wherein determining the second location within the target content is further based on a first size attribute of the textual data that is associated with the source content and a second size attribute of the textual data that is associated with the target content.

6. The one or more computer storage media of claim 5, wherein the first re-sizing option is further associated with a third width attribute and a third height attribute and the operations further comprise:
generating a second target content, wherein the second target content includes the third width attribute and the third height attribute;
causing simultaneous display, within the user interface, of the target content and the second target content; and
enabling a user, of the user interface, to provide a selection of at least one of the simultaneously displayed target content of the second target content.

7. The one or more computer storage media of claim 1, wherein a second region of the image data is located at the second location within the generated source content and the operations further comprise:
determining a feature encoded in the second region of image data;
updating the textual data to include at least one of an updated color attribute, an updated size attribute, an updated font attribute, or an updated alignment attribute of the textual data based on the determined feature encoded in the second region; and
generating the target content, wherein the updated textual data and the second region of the image data are layered at the second location within the target content based on the at least one of the updated color, size, font, or alignment attribute.

8. A computerized method for providing target content based on source content and a plurality of re-sizing options, the method comprising:
receiving, via a user interface, a first selection that indicates the source content of a first size, a second selection that indicates a second size for the target content, and a third selection that indicates a focal point of the source content at a first location within the source content;
determining a focal point of the target content based on the focal point of the source content and the second size for the target content;
generating the target content, wherein the target content conforms to the second size for the target content, and wherein the target content includes the focal point of the target content; and
causing display, within the user interface, of the target content.

9. The computerized method of claim 8, wherein generating the target content comprises including an editable layer of the source content in the target content.

10. The computerized method of claim 8, the operations further comprising:
generating a width scaling factor based on a comparison between a first width attribute associated with the source content of the first size and a second width attribute associated with the second size for the target content;
generating a height scaling factor based on a comparison between a first height attribute associated with the source content of the first size and a second height attribute associated with the second size for the target content and
determining a first location within the target content based on the width scaling factor and the height scaling factor.

11. The computerized method of claim 8, wherein textual data may be located at a second location within the source content, and wherein the textual data includes an association with a first size attribute and the operations further comprise:
determining a second size attribute based the first width and height attributes of the source content, the second width and height attributes associated with the second size for the target content, and the second location of the target content;
updating the textual data to include an association with the determined second size attribute;
generating the target content, wherein the updated textual data is located at the second location within the target content; and
causing display, within the user interface, of the target content such that the updated textual data located at the second location with the target content is displayed based on the second size attribute.

12. The computerized method of claim 8, wherein determining the second location within the target content is further based on a first size attribute of the textual data that is associated with the source content and a second size attribute of the textual data that is associated with the target content.

13. The computerized method of claim 13, wherein the second size for the target content is further associated with a third width attribute and a third height attribute and the operations further comprise:
generating a second target content, wherein the second target content includes the third width attribute and the third height attribute;
causing simultaneous display, within the user interface, of the target content and the second target content; and
enabling a user, of the user interface, to provide a selection of at least one of the simultaneously displayed target content of the second target content.

14. The computerized method of claim 8, wherein a second region of the image data is located at the second location within the generated source content and the operations further comprise:
determining a feature encoded in the second region of image data;
updating the textual data to include at least one of an updated color attribute, an updated size attribute, an updated font attribute, or an updated alignment attribute of the textual data based on the determined feature encoded in the second region; and
generating the target content, wherein the updated textual data and the second region of the image data are layered at the second location within the target content based on the at least one of the updated color, size, font, or alignment attribute.

15. A computer system comprising:
one or more processors; and
one or more non-transitory computer-readable storage media, coupled with the one or more processors, having instructions stored thereon, which, when executed by the one or more processors, cause the computing system to provide:
means for selecting source content, a focal point of the source content, and at least one of a plurality of re-sizing options for target content; and
means for generating the target content based on the source content and the plurality of re-sizing options.

16. The system of claim 15, further comprising a means for receiving, via a user interface, a first selection that indicates the source content, wherein the indicated source content includes a first width attribute, a first height attribute, image data, and textual data located at a second location within the source content.

17. The system of claim 15, further comprising a means for receiving, via the user interface, a second selection that indicates the focal point of the source content, wherein the focal point of the source content corresponds to a first region of the image data that is located at a first location within the source content.

18. The system of claim 15, further comprising a means for receiving, via the user interface, a third selection that indicates a first re-sizing option of the plurality of re-sizing options, wherein the first re-sizing option is associated with a second width attribute and a second height attribute.

19. The system of claim 15, further comprising determining a focal point of the target content based on the first width and the first height attributes of the source content, the second width and the second height attributes associated with the first re-sizing option, and the first location of the source content.

20. The system of claim 15, further comprising determining a second location within the target content based on the focal point of the target content, the second location within the source content, and the textual data, wherein the textual data is located at the second location within the target content.
